(19) United States
(12) Patent Application Publication
(10) Pub. No.: US 2008/0063064 A1
(43) Pub. Date: Mar. 13, 2008

(54) Method and System for Motion Compensated Temporal Filtering Using IIR Filtering

(76) Inventors: Alexander MacInnis, Ann Arbor, MI (US); Sheng Zhong, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 11/619,444

(22) Filed: Jan. 3, 2007

Related U.S. Application Data
(60) Provisional application No. 60/844,224, filed on Sep. 13, 2006.

(51) Int. Cl. H04N 11/02; H04B 1/66

(52) U.S. Cl. 375/240.16; 375/240.29

(57) ABSTRACT

Certain aspects of a method and system for motion compensated temporal filtering using infinite impulse response (IIR) filtering may include generating a corresponding non-motion compensated output picture of video data and a corresponding motion compensated output picture of video data from an infinite impulse response (IIR) filtered output picture of video data. The generated motion compensated output picture of video data and the generated corresponding non-motion compensated output picture of video data may be blended. At least one current output picture of video data may be generated by utilizing the blended motion compensated output picture of video data and the generated corresponding non-motion compensated output picture of video data and at least one previously generated output picture of video data.

### CROSS-REFERENCE TO RELATED APPLICATIONS/INCORPORATION BY REFERENCE

This patent application makes reference to, claims priority to and claims benefit from U.S. Provisional Patent Application Ser. No. 60/844,224 (Attorney Docket No. 17701 US01) filed on Sep. 13, 2006.

This application makes reference to:

U.S. application Ser. No. 11/314,679 (Attorney Docket No. 16899US01) filed Dec. 20, 2005;
U.S. application Ser. No. 11/313,592 (Attorney Docket No. 16903US01) filed Dec. 20, 2005; and
U.S. application Ser. No. ______ (Attorney Docket No. 17545US02) filed on even date herewith.

Each of the above stated applications is hereby incorporated by reference in its entirety.

### FIELD OF THE INVENTION

Certain embodiments of the invention relate to processing of video signals. More specifically, certain embodiments of the invention relate to a method and system for motion compensated temporal filtering using infinite impulse response (IIR) filtering.

### BACKGROUND OF THE INVENTION

Analog video may be received through broadcast, cable, and VCRs. The reception is often corrupted by noise, and therefore to improve the visual quality, noise reduction may be needed. Digital video may be received through broadcast, cable, satellite, Internet, and video discs. Digital video may be corrupted by noise, which may include coding artifacts, and to improve the visual quality, noise reduction may be beneficial. Various noise filters have been utilized in video communication systems such as set top boxes. However, inaccurate noise characterization, especially during scenes with motion, may result in artifacts caused by the filtering, which are more visually detrimental than the original noise.

In video system applications, random noise present in video signals, such as NTSC or PAL analog signals, for example, may result in images that are less than visually pleasing to the viewer. To address this problem, noise reduction (NR) operations may be utilized to remove or mitigate the noise present. Traditional NR operations may use either infinite impulse response (IIR) filtering based methods or finite impulse response (FIR) filtering based methods. IIR filtering may be utilized to significantly attenuate high frequency noise. However, IIR filtering may result in visual artifacts such as motion trails, jittering, and/or wobbling at places where there is object motion when the amount of filtering is not sufficiently conservative. In some instances, setting the IIR filtering conservatively may mitigate the noise removing capability even for places where there is little or no motion, such as a static area in video. As a result, there may be many instances where objectionable noise artifacts remain in the video signal.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for motion compensated temporal filtering using infinite impulse response (IIR) filtering, substantially as shown in and/or described in connection with at least one of the figures, as set forth more completely in the claims.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram of an exemplary video noise reduction system, in accordance with an embodiment of the invention.

FIG. 2 is a diagram illustrating exemplary consecutive video pictures for noise reduction operations, in connection with an embodiment of the invention.

FIG. 3 is a block diagram of an exemplary infinite impulse response (IIR) filtering system with noise reduction, in accordance with an embodiment of the invention.

FIG. 4A is a block diagram illustrating exemplary motion compensated temporal filtering system using infinite impulse response (IIR) filtering, in accordance with an embodiment of the invention.

FIG. 4B is a block diagram of an alternative embodiment illustrating exemplary motion compensated temporal filtering system using infinite impulse response (IIR) filtering, in accordance with an embodiment of the invention.

FIG. 4C is a block diagram of another embodiment illustrating exemplary motion compensated temporal filtering system using infinite impulse response (IIR) filtering, in accordance with an embodiment of the invention.

FIG. 5 is an illustration of an exemplary motion estimation method in the motion compensated temporal filtering (MCTF) system for an MC path, in accordance with an embodiment of the invention.

FIG. 6A is a block diagram of a non-MC path of an exemplary motion compensated temporal filtering system using infinite impulse response (IIR) filtering, in accordance with an embodiment of the invention.

FIG. 6B is a block diagram of an MC path of an exemplary motion compensated temporal filtering system using infinite impulse response (IIR) filtering, in accordance with an embodiment of the invention.

FIG. 6C is a block diagram of an MC path of another exemplary motion compensated temporal filtering system using infinite impulse response (IIR) filtering, in accordance with an embodiment of the invention.

FIG. 7 is a flowchart illustrating exemplary steps for motion compensated temporal filtering system using infinite impulse response (IIR) filtering, in accordance with an embodiment of the invention.

### DETAILED DESCRIPTION OF THE INVENTION

Certain embodiments of the invention may be found in a system and/or method for motion compensated temporal filtering using infinite impulse response (IIR) filtering. Certain aspects of a method may include generating a corresponding non-motion compensated output picture of video data from an infinite impulse response (IIR) filtered output picture of video data. The motion compensated output picture of video data and the generated corresponding non-motion compensated output picture of video data may be blended. One or more current output pictures of video data may be generated by utilizing the blended motion compensated output picture of video data and the generated corresponding non-motion compensated output picture of video data and one or more previously generated output pictures of video data.

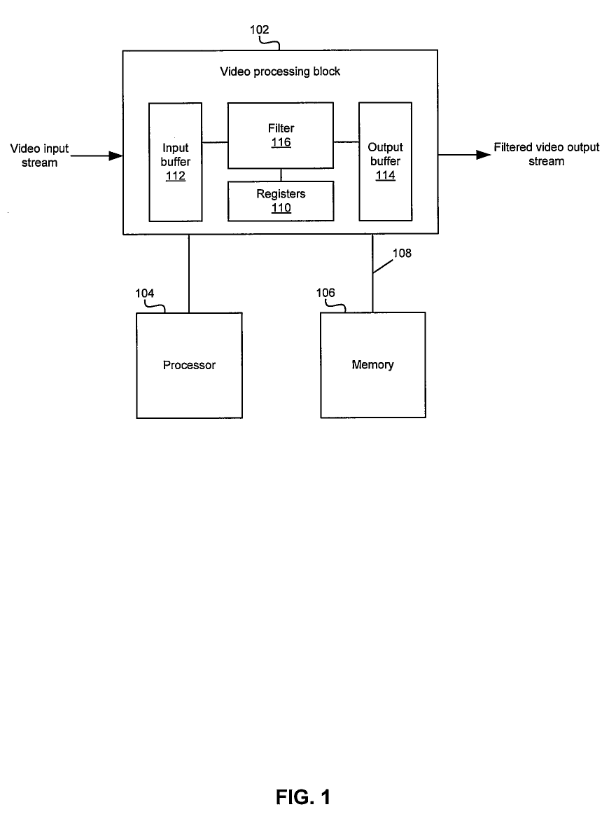

FIG. 1 is a block diagram of an exemplary video noise reduction system, in accordance with an embodiment of the invention. Referring to FIG. 1, there is shown a video processing block 102, a processor 104, a memory 106, and a data/control bus 108. The video processing block 102 may comprise registers 110 and filter 116. In some instances, the video processing block 102 may also comprise an input buffer 112 and/or an output buffer 114. The video processing block 102 may comprise suitable logic, circuitry, and/or code that may be enabled to filter pixels in a video picture or a video picture from a video input stream to reduce noise. For example, video frame pictures may be utilized in video systems with progressive video signals while video field pictures may be utilized in video systems with interlaced video signals. Video fields may alternate parity between top fields and bottom fields. A top field and a bottom field in an interlaced system may be deinterlaced or combined to produce a video frame.

The video processing block 102 may be enabled to receive a video input stream and, in some instances, to buffer at least a portion of the received video input stream in the input buffer 112. In this regard, the input buffer 112 may comprise suitable logic, circuitry, and/or code that may be enabled to store at least a portion of the received video input stream. Similarly, the video processing block 102 may be enabled to generate a filtered video output stream and, in some instances, to buffer at least a portion of the generated filtered video output stream in the output buffer 114. In this regard, the output buffer 114 may comprise suitable logic, circuitry, and/or code that may be enabled to store at least a portion of the filtered video output stream.

The filter 116 in the video processing block 102 may comprise suitable logic, circuitry, and/or code that may be enabled to perform an IIR filtering operation with noise reduction (IIR-NR) on the current pixel. In this regard, the filter 116 may be enabled to operate in a plurality of filtering modes, where each filtering mode may be associated with one of a plurality of supported filtering operations. The filter 116 may utilize video content, filter coefficients, threshold levels, and/or constants to generate the filtered video output stream in accordance with the filtering mode selected. In this regard, the video processing block 102 may generate blending factors to be utilized with the appropriate filtering mode selected. The registers 110 in the video processing block 102 may comprise suitable logic, circuitry, and/or code that may be enabled to store information that corresponds to filter coefficients, threshold levels, and/or constants, for example. Moreover, the registers 110 may be enabled to store information that corresponds to a selected filtering mode.

The processor 104 may comprise suitable logic, circuitry, and/or code that may be enabled to process data and/or perform system control operations. The processor 104 may be enabled to control at least a portion of the operations of the video processing block 102. For example, the processor 104 may generate at least one signal to control the selection of the filtering mode in the video processing block 102. Moreover, the processor 104 may be enabled to program, update, and/or modify filter coefficients, threshold levels, and/or constants in at least a portion of the registers 110. For example, the processor 104 may generate at least one signal to retrieve stored filter coefficients, threshold levels, and/or constants that may be stored in the memory 106 and transfer the retrieved information to the registers 110 via the data/control bus 108. The memory 106 may comprise suitable logic, circuitry, and/or code that may be enabled to store information that may be utilized by the video processing block 102 to reduce noise in the video input stream. The processor 104 may also be enabled to determine noise levels for a current video picture based on an early-exit algorithm (EEA) or an interpolation estimate algorithm (IEA), for example. The memory 106 may be enabled to store filter coefficients, threshold levels, and/or constants, for example, to be utilized by the video processing block 102. U.S. application Ser. No. 11/313,592 (Attorney Docket No. 16903US01) filed Dec. 20, 2005, provides a detailed description of the early-exit algorithm (EEA) and the interpolation estimate algorithm (IEA), and is hereby incorporated by reference in its entirety.

In operation, the processor 104 may select a filtering mode of operation and may program the selected filtering mode into the registers 110 in the video processing block 102. Moreover, the processor 104 may program the appropriate values for the filter coefficients, threshold levels, and/or constants into the registers 110 in accordance with the selected filtering mode. The video processing block 102 may receive the video input stream and may filter pixels in a video picture in accordance with the selected filtering mode. In some instances, the video input stream may be stored in the input buffer 112 before processing. The video processing block 102 may generate the appropriate blending factors needed to perform the noise reduction filtering operation selected by the processor 104. The video processing block 102 may generate the filtered video output stream after performing the noise reduction filtering operation. In some instances, the filtered video output stream may be stored in the output buffer 114 before being transferred out of the video processing block 102.

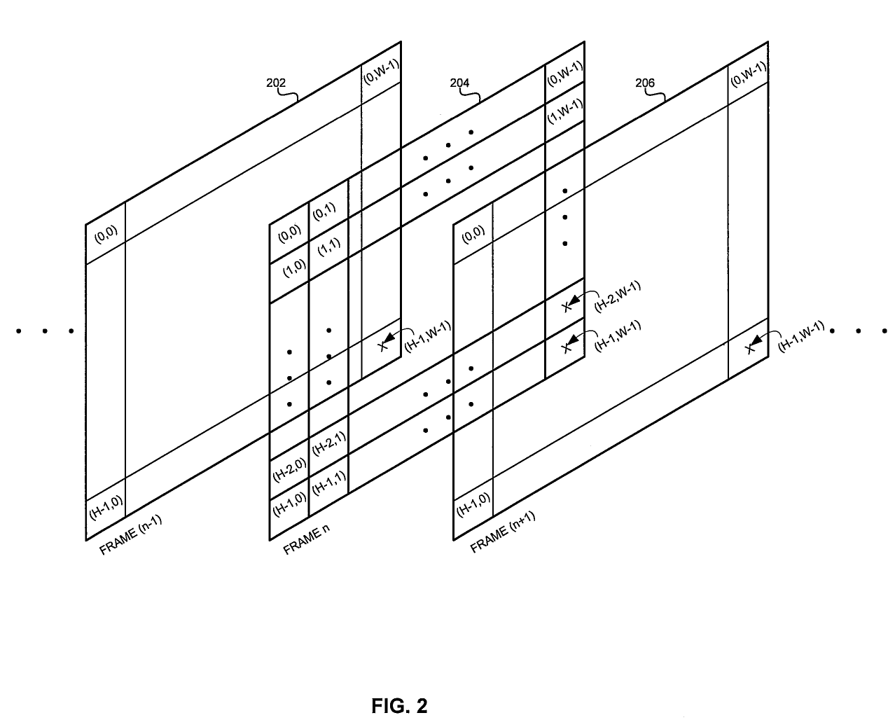

FIG. 2 is a diagram illustrating exemplary consecutive video pictures for noise reduction operations, in connection with an embodiment of the invention. Referring to FIG. 2, there is shown a current video picture 204, a previous video picture 202, and a next video picture 206. The current video picture 204 or PICTURE n may correspond to a current picture being processed by the video processing block 102 in FIG. 1. The previous video picture 202 or PICTURE (n−1) may correspond to an immediately previous picture to the current video picture 204. The next video picture 206 or PICTURE (n+1) may correspond to an immediately next picture to the current video picture 204. The previous video picture 202, the current video picture 204, and/or the next video picture 206 may be processed directly from the video input stream or after being buffered in the video processing block 102, for example. The current video picture 204, the previous video picture 206, and the next video picture 208 may comprise luma (Y) and/or chroma (Cb, Cr) information. In embodiments where video fields are utilized as pictures, the previous video picture 202 may refer to the previous field of the same parity as the current video picture 204, and the next video picture 206 may refer to the next field of the same parity as the current picture 204. The previous, current and next video fields of the same parity may be referred to as consecutive video pictures.

Pixels in consecutive video pictures are said to be collocated when having the same picture location, that is, . . . , Pₙ₋₁ (x, y), Pₙ (x, y), Pₙ₊₁ (x, y), . . . , where Pₙ₋₁ indicates a pixel value in the previous video picture 202, Pₙ indicates a pixel value in the current video picture 204, Pₙ₊₁ indicates a pixel value in the next video picture 206, and (x, y) is the common picture location between pixels. As shown in FIG. 2, for the picture location, (x, y) is such that x=0, 1, . . . , W−1 and y=0, 1, . . . , H−1, where W is the picture width and H is the picture height, for example.

Operations of the video processing block 102 in FIG. 1 need not be limited to the use of exemplary consecutive video pictures as illustrated in FIG. 2. For example, the video processing block 102 may perform filtering operations on consecutive video fields of the same parity, that is, on consecutive top fields or consecutive bottom fields. When performing noise reduction operations on consecutive video fields of the same parity, pixels in the video processing block 102 are said to be collocated when having the same picture location, that is, . . . , Pₙ₋₁ (x, y), Pₙ (x, y), Pₙ₊₁ (x, y), . . . , where Pₙ₋₁ indicates a pixel value in a previous video field, Pₙ indicates a pixel value in a current video field, Pₙ₊₁ indicates a pixel value in a next video field, and (x, y) is the common picture location between pixels.

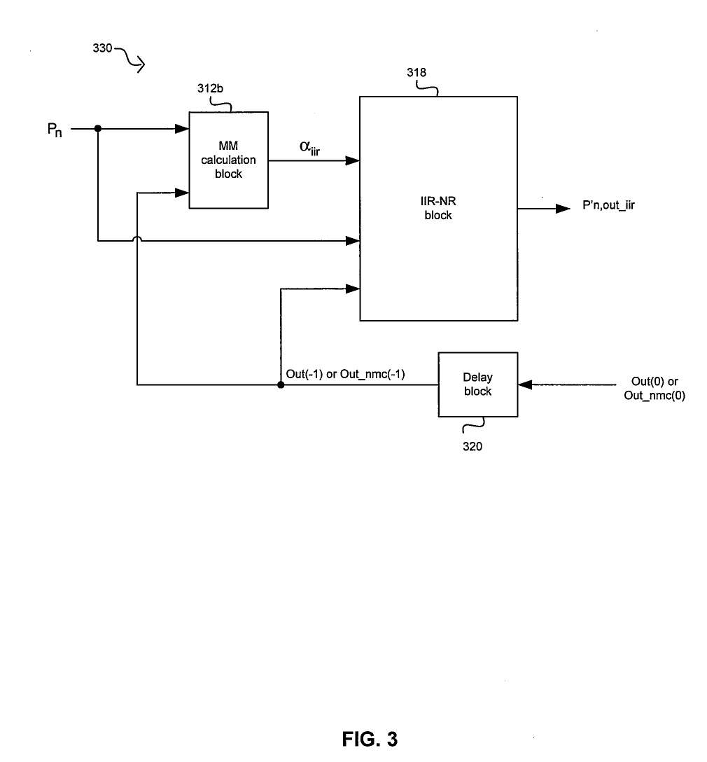

FIG. 3 is a block diagram of an exemplary infinite impulse response (IIR) filtering system with noise reduction, in accordance with an embodiment of the invention. Referring to FIG. 3, there is shown an IIR filtering system 330 that may comprise an MM calculation block 312b, an IIR noise reduction (IIR-NR) block 318, and a delay block 320. The IIR filtering system 330 may be implemented as a portion of the video processing block 102 in FIG. 1, for example. The MM calculation block 312b may comprise suitable logic, circuitry, and/or code that may be enabled to determine a motion metric (MM) parameter based on contents from a current pixel, Pₙ, and from a previously generated output picture Out(−1) or a previously generated non-MC output signal Out_nmc(−1). The MM calculation block 312b may utilize the MM parameter to determine an IIR blending factor, αᵢᵢᵣ. The IIR blending factor, αᵢᵢᵣ, may be determined by a mapping operation of the motion metric information. This mapping operation may respond rapidly to motion to avoid unnecessary filtering in moving areas, for example.

The IIR-NR block 318 may comprise suitable logic, circuitry, and/or code that may be enabled to IIR filter the current pixel, Pₙ. The IIR-NR block 318 may also be enabled to generate an IIR-blended current pixel given by the expression:

P′_{n,out}_{_{—}}ᵢᵢᵣ(x,y)=αᵢᵢᵣ·Pₙ(x,y)+(1−αᵢᵢᵣ)·Out(−1), (3)

where the IIR blending factor, αᵢᵢᵣ, controls the contribution of the previously generated output picture Out(−1) to the IIR-blended current pixel. The delay block 320 may comprise suitable logic, circuitry, and/or code that may be enabled to delay by one video picture the transfer of the recursive feedback from the output of the IIR-NR block 318 to the MM calculation block 312b and to the input of the IIR-NR block 318. In this regard, both the MM calculation block 312b and the IIR-NR block 318 may utilize a recursive feedback operation based on the previously generated output picture Out(−1) or a previously generated non-MC output signal Out_nmc(−1).

In operation, the current pixel, Pₙ and the previously generated non-MC output signal Out_nmc(−1) may be received by the MM calculation block 312b and the IIR-NR block 318. The MM calculation block 312b may generate the IIR blending factor, αᵢᵢᵣ. The IIR-NR block 318 may IIR filter the current pixel, Pₙ, and may utilize the current pixel and the previously generated output picture Out(−1) to perform the operation described by equation (3).

Motion-adaptive IIR filtering methods may achieve significant noise reduction but may result in artifacts such as motion trails and/or blurring of moving objects. To avoid these motion artifacts, IIR noise reduction operations may be configured conservatively, limiting, in some instances, the ability to reduce noise components.

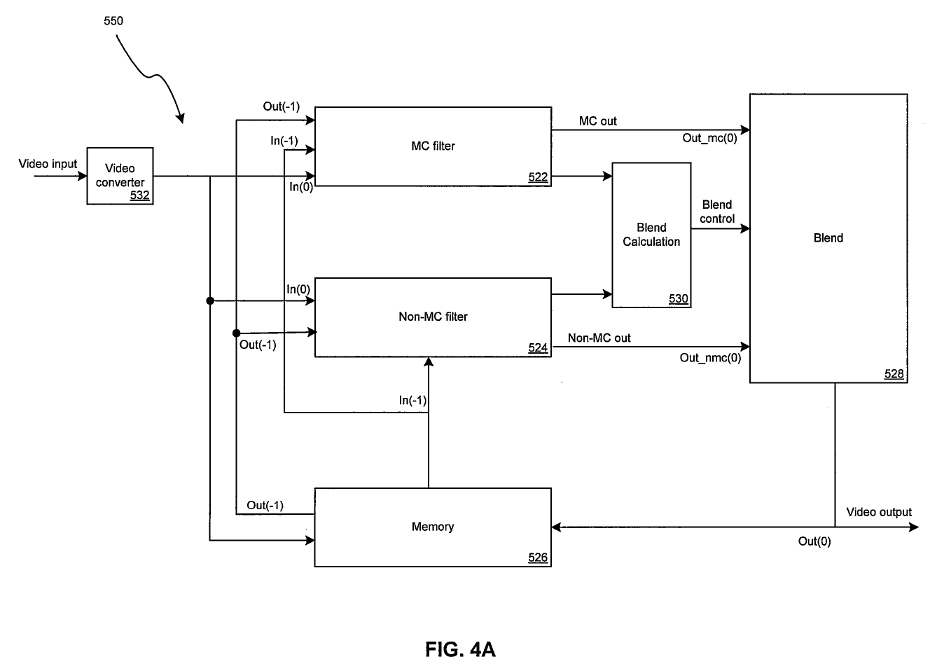

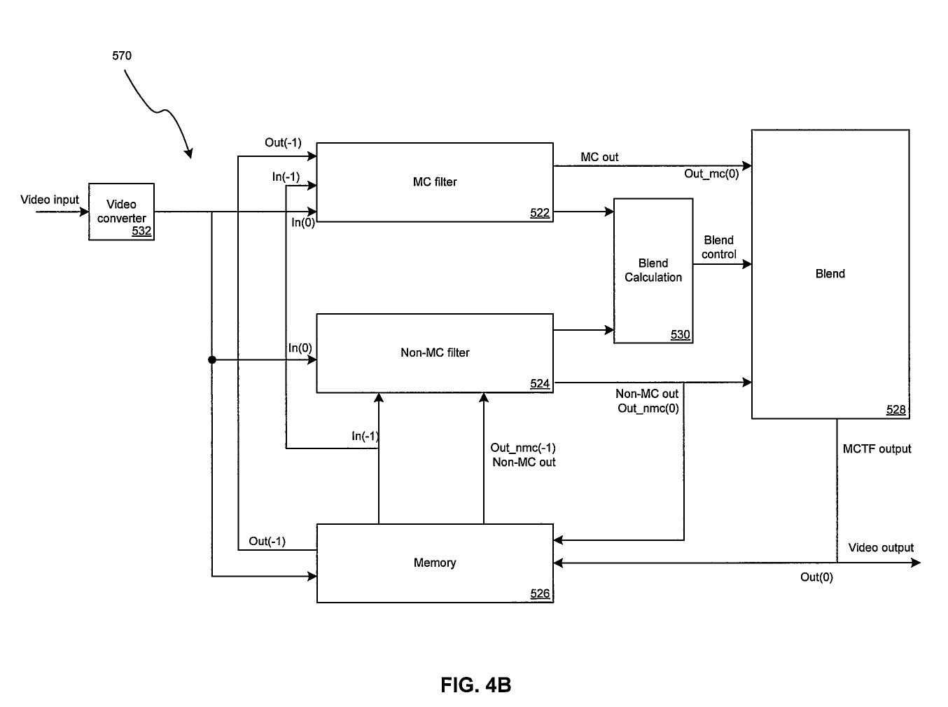

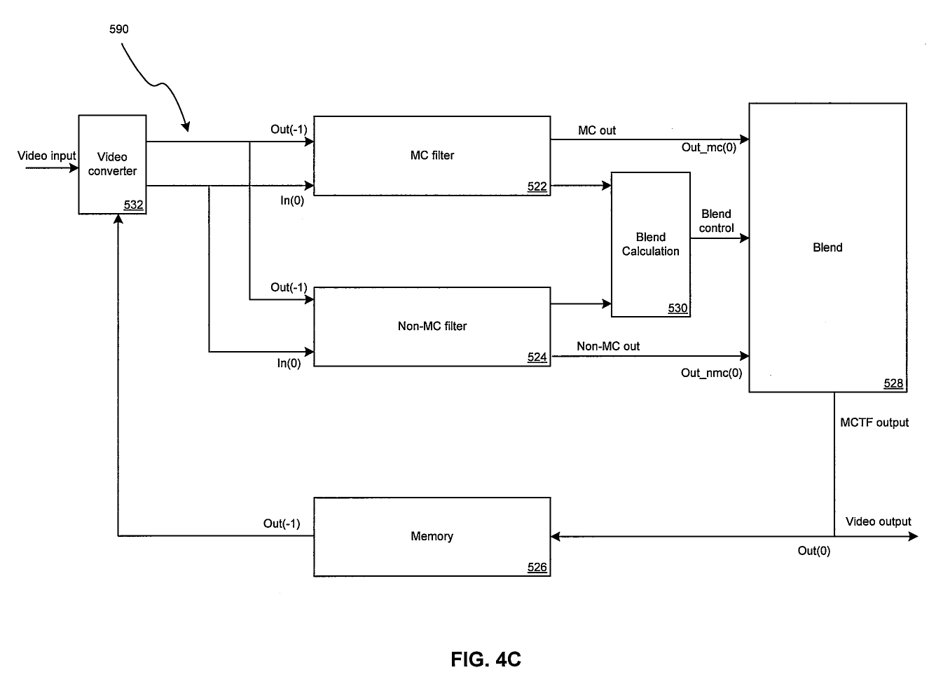

FIG. 4A is a block diagram illustrating an exemplary motion compensated temporal filtering system using infinite impulse response (IIR) filtering, in accordance with an embodiment of the invention. Referring to FIG. 4A, there is shown a MCTF system 550 that comprises a video converter 532, a motion compensated (MC) filter block 522, a non-MC filter block 524, a memory 526, a blend calculation block 530, and a blend block 528.

The video converter 532 may comprise suitable logic, circuitry and/or code that may be enabled to receive video data from a video source in YCbCr 4:2:2 format, for example. The video converter 532 may be enabled to convert the received video data to YCbCr in the 4:4:4 format before motion estimation and motion compensation operations are performed to facilitate motion estimation and motion compensation of chroma components. The chroma samples may be interpolated to the same sample density as the luma samples. The 4:2:2 to 4:4:4 interpolation may utilize a 4-tap filter, for example. The even indexed 4:4:4 chroma pixels may be generated from the half-value indexed 4:2:2 chroma samples. The odd indexed 4:4:4 chroma samples may be interpolated using four 4:2:2 chroma samples, for example, two to the left and two to the right of the current position.

The MC filter block 522 may comprise suitable logic, circuitry and/or code that may be enabled to perform motion compensation, motion estimation, and temporal filtering operation on the incoming video data. The MC filter block 522 may be enabled to receive a previous input picture In(−1), a previous output picture Out(−1) from memory 526, and a current input picture In(0) from the video converter 532. The MC filter block 522 may be enabled to utilize the received previous input picture In(−1), a previous output picture Out(−1) from memory 526, and a current input picture In(0) from the video converter 532 to generate a current output signal Out_mc(0) to the blend block 518 and the blend calculation block 520.

The non-MC filter block 524 may comprise suitable logic, circuitry and/or code that may be enabled to perform motion adaptive temporal filtering (MATF). The non-MC filter block 524 may comprise an IIR filter. The non-MC filter block 524 may be enabled to receive a current input picture In(0) from the video converter 532. The non-MC filter block 524 may be enabled to receive the previous input picture In(−1), and a previous output picture Out(−1) from the memory 526. The previous output picture Out(−1) may be recursively fed back to the non-MC filter block 524. The non-MC filter block 524 may be enabled to utilize the received previous input picture In(−1), a previous output picture Out(−1), and a current input picture In(0) to generate an output signal Out_nmc(0) to the blend block 528 and the blend calculation block 530.

The memory 526 may comprise suitable logic, circuitry, and/or code that may be enabled to store at least a portion of consecutive video pictures. The memory 526 may be enabled to store a previous input picture In(−1), and a previous output picture Out(−1). The memory 526 may be enabled to receive a current input picture In(0) from the video converter 532, and a current output picture Out(0) from the blend block 528.

The blend calculation block 530 may comprise suitable logic, circuitry and/or code that may be enabled to receive the output signals generated from the MC filter block 522 and the non-MC filter block 524 and generate a blend control signal to the blend block 528. The blend calculation block 530 may be enabled to blend together the 4:2:2 outputs of the MC filter block 522 and the non-MC filter block 524. The blend calculation block 530 may be enabled to generate a blend control variable that may represents the confidence metric that a MV may represent the motion of the content at the current pixel In(0). The MV selected for the MC operation may be referred to as MV#0, or the MV with the lowest measured cost.

The blend calculation block 530 may be enabled to estimate the confidence metric of MV#0 by utilizing a combination of three metrics. For example, a first metric (cost_MV#1−cost_MV#0), which indicates how much better MV#0 is than the next lowest cost MV, or MV#1, a second metric (cost_zero_MV−cost_MV#0), which indicates how much better MV#0 is compared to the zero (0,0) vector, and a third metric may be the horizontal edge strength, edge_strength_adj. These three metrics may be combined as follows:

confidence_{—}mv=max((cost_zero_{—}MV−cost_{—}MV#0), (cost_{—}MV#1−cost_{—}MV#0) (11a)

confidence=max(0, confidence_{—}mv−edge_strength_{—}adj) (11b)

The value of MV#1 may not affect the result except when MV#0 is the zero MV, since for other cases of MV#0, (cost_zero_MV>=cost_MV#1) and (cost_zero_MV−cost_MV#0)>=(cost_MV#1−cost_MV#0). Therefore, the MV#1 may not be calculated except when MV#0=zero_MV. The motion estimation (ME) may be performed once for every non-overlapping pixel block of size 3×1, for example. For the 3 pixels in the pixel block (of 3×1), MV#0, MV#1 and the (0,0)−MV may be equal. The edge_strength_adj value may be computed once for every 3×1 pixel block, for example, and the same confidence value may be utilized for blending each of the 3 pixels in the pixel block. The confidence value may be processed through a non-linearity to generate a blending control variable blend_MC_NonMC. The non-linearity may be in the form of K4*(1−K5/(d*d)), where d=4*confidence/(size of window), for example, and K4 and K5 are parameters that may be set according to a degree of filtering corresponding to a noise level of an input video and/or the expectations of a subsequent encoder.

The blend block 528 may comprise suitable logic, circuitry and/or code that may be enabled to receive a plurality of input signals: a MC out signal (Out_mc(0)), a blend control signal from the blend calculation block 530, and a non-MC out signal (Out_nmc(0)) from the non-MC filter block 524. The blend block may be enabled to generate a current output picture Out(0) utilizing the received signals: a MC out signal (Out_mc(0)), a blend control signal from the blend calculation block 530, and a non-MC out signal (Out_nmc(0)).

The output of the blend block 528 may be generated by blending the outputs of the MC filter block 522 (Out_mc(0)), and the output of the non-MC filter block 524 (Out_nmc(0)) as follows:

Out(0)=(blend_{mc}_{_{—}}_{nonmc}*Out_{—}mc(0)+(256−blend_{mc}_{_{—}}_{nonmc})*Out_{—}nmc(0)+128)/256 (12)

The blending factor blend_{mc}_{_{—}}_{nonmc} may be utilized for the three luma pixels in a 3×1 block, for example. The chroma blending may be performed for the 4:2:2 format or the even indexed chroma samples may be blended.

The blending factor for the non MC path and the MC path including non-linearities may be calculated as follows:

$$\begin{matrix}m = \frac{4 * confidence}{me\_window \_size \_w * me\_window \_size \_h} & ( 13 a ) \\ {blend}_{mc\_nonmc} = {K}_{mc\_nonmc , 0} ( 1 - \frac{{K}_{mc\_nonmc , 1}}{{m}^{2}} ) & ( 13 b ) \\ {blend}_{mc\_nonmc} = clip 3 ( {blend}_{mc\_nonmc} , 0 , 256 ) & ( 13 c )\end{matrix}$$

where K_{mc}_{_{—}}_{nonmc,0} and K_{mc}_{_{—}}_{nonmc,1} are parameters that may be set according to the desired degree of filtering corresponding to the noise level of the input video and/or the expectations of a subsequent encoder and the function clip3( ) may be defined as follows:

```
int clip3(int x, int y, int z)
{
    if(x<y) return y;
    else if(x>z) return z;
    else return x;
}
```

Combining equations (11b) and (13a), the normalized confidence value may be approximated as follows:

m>>max(0,(a₀*(confidence_{—}mv−edge_strnegth_{—}adj))>>10) (13d)

where

a₀=((4*1024)/(me_window_size_{—}w*me_window_size_{—}h)) (13e)

In the above implementation, a0 may be a programmable unsigned integer value, for example, since the window size may be programmable. The constants in equations (13d) and (13e) may be set to facilitate fixed point operations; they are not a restriction for the invention.

FIG. 4B is a block diagram of an alternative embodiment illustrating exemplary motion compensated temporal filtering system using infinite impulse response (IIR) filtering, in accordance with an embodiment of the invention. Referring to FIG. 4B, there is shown a MCTF system 570 that comprises a video converter 532, a motion compensated (MC) filter block 522, a non-MC filter block 524, a memory 526, a blend calculation block 530, and a blend block 528. The various blocks in FIG. 4B may be substantially as described in FIG. 4A.

The non-MC path block 524 may be enabled to receive a current input picture In(0) from the video converter 532. The non-MC path block 524 may be enabled to receive the previous input picture In(−1), and a previous non MC output signal (Out_nmc(−1)) from the memory 526. The previous non MC output signal (Out_nmc(−1)) may be recursively fed back to the non-MC filter block 522. The memory bandwidth utilized by this embodiment may be higher than the bandwidth utilized by the system of FIG. 4A. The non-MC filter block 524 may be enabled to utilize the received previous input picture In(−1), a previous non MC output signal (Out_nmc(−1)), and a current input picture In(0) to generate an output signal Out_nmc(0) to the blend block 528 and the blend calculation block 530.

The memory 526 may be enabled to store a previous input picture In(−1), a previous output picture Out(−1), and a previous non MC output signal (Out_nmc(−1)). The memory 526 may be enabled to receive a current input picture In(0) from the video converter 532, a current non-MC output signal (Out_nmc(0)) and a current output picture Out(0) from the blend block 528.

FIG. 4C is a block diagram of another embodiment illustrating exemplary motion compensated temporal filtering system using infinite impulse response (IIR) filtering, in accordance with an embodiment of the invention. Referring to FIG. 4C, there is shown a MCTF system 590 that comprises a video converter 532, a motion compensated (MC) filter block 522, a non-MC filter block 524, a memory 526, a blend calculation block 530, and a blend block 528. The various blocks in FIG. 4C may be substantially as described in FIG. 4A.

The non-MC path block 524 may be enabled to receive a current input picture In(0) and a previously generated output picture Out(−1) from the video converter 532. The non-MC filter block 524 may be enabled to utilize the received current input picture In(0), and the previously generated output picture Out(−1) to generate an output signal Out_nmc(0) to the blend block 528 and the blend calculation block 530.

The memory 526 may be enabled to receive a current output picture Out(0) from the blend block 528. The memory 526 may be enabled to store a previously generated output picture Out(−1) and feed back the previously generated output picture Out(−1) to the video converter 532.

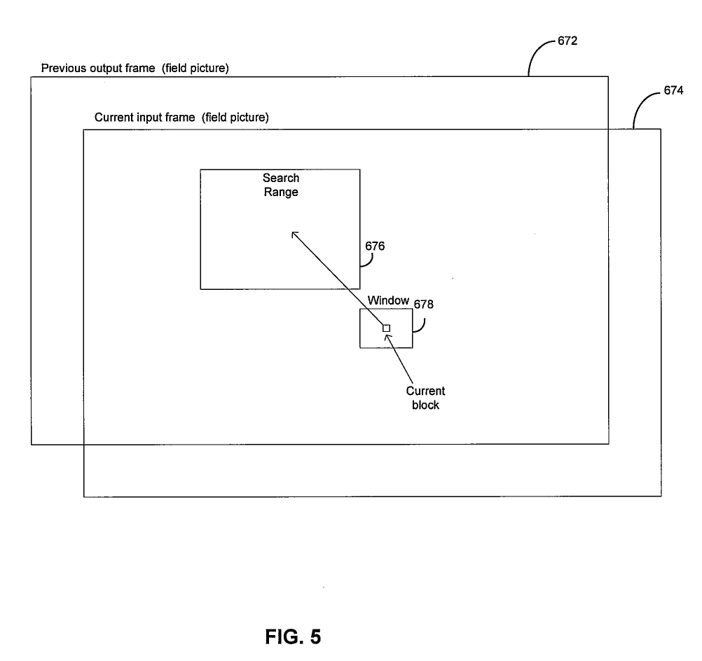

FIG. 5 is an illustration of an exemplary motion compensated temporal filtering (MCTF) system for MC path, in accordance with an embodiment of the invention. Referring to FIG. 5, there is shown a previous output picture Out(−1) 672, a current input picture In(0) 674, a search range block 676, and a window block 678.

In operation, the MC path of the MCTF may perform motion estimation (ME) to determine a motion vector (MV) to represent motion of image content at each current block. The value of a metric representing the confidence of the validity of the resulting motion vector may be determined. Motion compensation of each current block may be performed from the previous MCTF output image in the search range 676 of previous output picture Out(−1) 672 by utilizing a motion vector. The amount of residual signal and noise after motion compensation may be measured at each pixel. The MCTF may include performing IIR temporal filtering of the input image or current input picture In(0) 674 in conjunction with the motion compensated previous output image or previous output picture Out(−1). The IIR filter may be controlled by the measurement of the MC residual after processing by a non-linear transfer function.

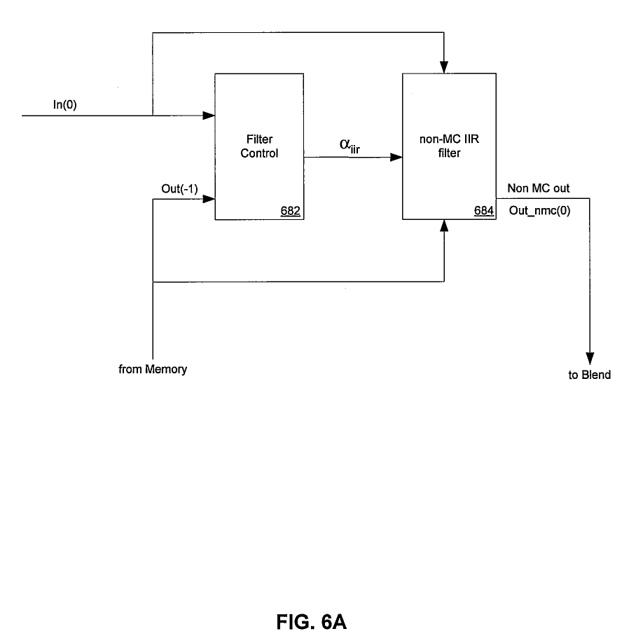

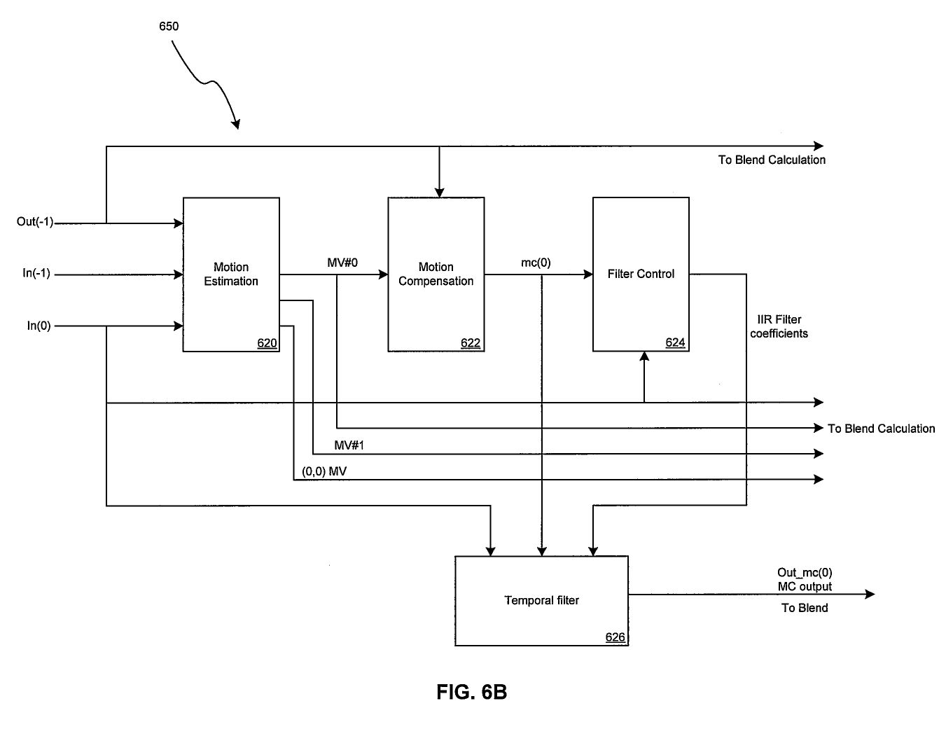

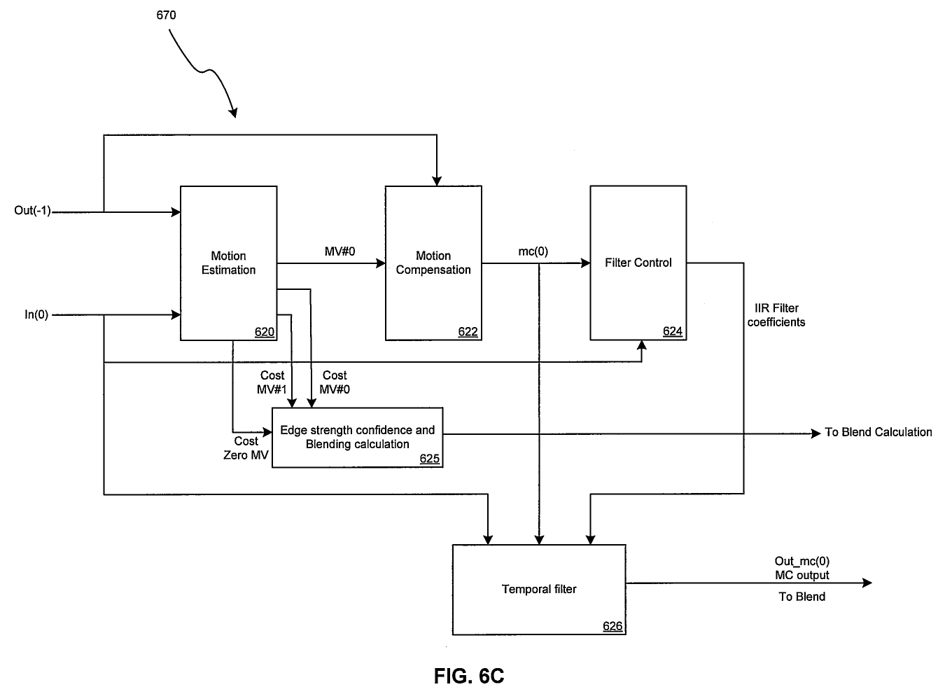

FIG. 6A is a block diagram of a non-MC path of an exemplary motion compensated temporal filtering system using infinite impulse response (IIR) filtering, in accordance with an embodiment of the invention. Referring to FIG. 6A, there is shown a filter control block 682, and a non-MC IIR filter block 684.

The filter control block 682 may comprise suitable logic, circuitry and/or code that may be enabled to calculate the differences between two pictures of video over a measurement window. This measurement window may be referred to as a filter cost window of the non-MC IIR filter block 684.

In accordance with an embodiment of the invention, the filter cost window size may be configurable, for example, to be 7×5 or 5×3. The non-MC IIR filter block 684 cost window size may also be independently configurable. The MC filter 522 and non-MC IIR filter block 684 cost window sizes may be independently configurable.

The filter control block 682 may be enabled to compare the current input picture In(0) at each pixel with the previous output picture Out(−1) without motion compensation. The filter cost metric may be represented, for example, as follows when configured to use chroma SSD:

Costₙₒₙ_{_{—}}_{mc}_{_{—}}ᵢᵢᵣ=(2*luma_{—}SAD+abs(Cb_{—}SSD)+abs(Cr_{—}SSD)+2)/4 (20a)

### Similarly, the filter cost metric may be represented, for example, as follows when configured to use chroma SAD:

costₙₒₙ_{_{—}}_{mc}_{_{—}}ᵢᵢᵣ=(2*luma_{—}SAD+abs(Cb_{—}SAD)+abs(Cr_{—}SAD)+2)/4 (20b)

### The weighting factors in equations (20a) and (20b) may favor luma more than each chroma as luma may carry more information.

The output of the filter control block 682 may be specified, for example, as follows:

Out_{—}nmc(0)=((αᵢᵢᵣ*In(0))+(256−αᵢᵢᵣ)*(Out(−1))+128)/256 (21)

where αᵢᵢᵣ is the output of the filter control block 624, and Out(−1) is the previous output picture. In another embodiment of the invention, the even indexed samples may be filtered although both In(0) and Out(−1) have been converted to the 4:4:4 format for the chroma sample filtering operations, which may lower the cost of the filter without any significant impact on visual quality.

The non MC IIR filter block 684 may comprise suitable logic, circuitry and/or code that may be enabled to generate an output Out_nmc(0) to the blend block 528. This output may be blended with the MC filter 522 output Out_mc(0) to generate the MCTF output. The filter cost value (costₙₒₙ_{_{—}}_{mc}_{_{—}}ᵢᵢᵣ) may be mapped to filter coefficients of the non MC IIR filter block 684 by utilizing the following non-linear transfer function:

αᵢᵢᵣ=K₂ (1−(K₃/d²)) (22)

where d=4*filter_cost/(size of window), for example, and K2 and K3 are parameters that may be set according to the desired degree of filtering corresponding to the noise level of the input video and/or the expectations of a subsequent encoder.

The non MC path blending factor including non-linearities may be calculated, for example, as follows:

$$\begin{matrix}m = \frac{4 * {cost}_{non\_mc \_iir}}{cost\_window \_size \_w * cost\_window \_size \_h} & ( 23 a ) \\ {α}_{iir} = {K}_{non\_mc \_iir , 0} ( 1 - \frac{{K}_{non\_mc \_iir , 1}}{{m}^{2}} ) & ( 23 b ) \\ {α}_{iir} = clip 3 ( {α}_{iir} , LOW\_THD , 256 ) & ( 23 c )\end{matrix}$$

where LOW_THD may be a lower threshold value, Kₙₒₙ_{_{—}}_{mc}_{_{—}}_{iir,0} and Kₙₒₙ_{_{—}}_{mc}_{_{—}}_{iir,1} are parameters that may be set according to the desired degree of filtering corresponding to the noise level of the input video and/or the expectations of a subsequent encoder and the function clip3( ), the latter of which may be defined using exemplary pseudo code as follows:

```
int clip3(int x, int y, int z)
{
    if(x<y) return y;
    else if(x>z) return z;
    else return x;
}
```

where x, y, and z may be suitable rational values.

In the equations (23a), (23b) and (23c), the cost and confidence values may be normalized by scaling. The division by the window size may be costly. Combining equations (20a) and (20b) with equation (23a), the normalized cost for the non MC path may be approximated, for example, as follows:

m>>(c₀*luma_{—}SAD+c₁*abs(Cb_{—}SSD)+c₁*abs(Cr_{—}SSD))>>14 (23d)

or

m>>(c₀*luma_{—}SAD+c₁*abs(Cb_{—}SAD)+c₁*abs(Cr_{—}SAD))>>14 (23e)

where

c₀=((4*8192)/(cost_window_size_{—}w*cost_window_size_{—}h) (23f)

c₁=((4*4096)/(cost_window_size_{—}w*cost_window_size_{—}h) (23g)

In the above implementation, c0 and c1 may be programmable unsigned integer values, for example, since the window size is programmable and may be constrained, for example, as follows:

c₀+2*c₁=(int)(65536/(cost_window_size_{—}w*cost_window_size_{—}h)) (23h)

FIG. 6B is a block diagram of an MC path of an exemplary motion compensated temporal filtering system using infinite impulse response (IIR) filtering, in accordance with an embodiment of the invention. Referring to FIG. 6B, there is shown a MC filter module 650 that comprises a motion estimation block 620, a motion compensation block 622, a filter control block 624, and a temporal filter block 626.

The motion estimation (ME) block 620 may comprise suitable logic, circuitry and/or code that may be enabled to search a previous MCTF output picture Out(−1) after being converted to the 4:4:4 format in the search range 676 to find a motion vector (MV) with a suitable fit, for example, lowest cost, with respect to a current input picture In(0), or to search first a previous input picture In(−1) in the search range 676 to find a motion vector (MV) in integer precision with a suitable fit, for example, lowest cost, with respect to a current input picture In(0), and then search a previous MCTF output picture Out(−1) around the first MV to find a motion vector in sub-pixel precision with a suitable fit, for example, lowest cost, with respect to a current input picture In(0). Alternatively, the motion estimation function may be performed without converting the previous output or the current input to 4:4:4 format. Suitable interpolation may be applied to the chroma samples to enable the motion estimation function. The previous MCTF output picture Out(−1) and the current input picture In(0) may be converted to the 4:4:4 format by the video converter 532. The set of pixels that are assigned one MV may be referred to as a pixel block. A pixel block may be as small as 1×1, or one pixel, or it may be larger. For example, the pixel block size may be 3×1 i.e. 3 pixels wide and 1 pixel tall. A pixel block size larger than 1×1 may be chosen to reduce implementation complexity for motion estimation and motion compensation. The implementation cost of the ME function may be related to the inverse of the pixel block size. The motion estimation (ME) block 620 may be enabled to receive the previous output picture Out(−1), the previous input picture In(−1), and the current input picture In(0) and generate a plurality of motion vectors, MV#0 and MV#1, for example.

Each candidate motion vector may be evaluated using a cost metric measured over a window 678 of pixels. The size of the window 678 may be independent of the size of the pixel block. For example, the ME window size may be 7×5, i.e. 7 pixels wide and 5 pixels high. The ME block 620 may utilize a cost metric that may be a sum of absolute differences (SAD) for luma samples and sum of signed differences (SSD) for chroma samples. These cost metrics may be combined into one cost as follows, for example:

cost_{mc}_{_{—}}ᵢᵢᵣ=(2*luma_{—}SAD+abs(Cb_{—}SSD)+abs(Cr_{—}SSD)+2)/4 (24a)

where Cb_SSD and Cr_SSD are the SSD values of Cb and Cr components respectively. Notwithstanding, the cost metric may also be denoted as follows: cost_{mc}_{_{—}}ᵢᵢᵣ=(2*luma_SAD+Cb_SAD+Cr_SAD+2)/4, where Cb_SAD and Cr_SAD are the SAD values of Cb and Cr components respectively. Alternative cost metrics and combinations of cost metrics may be used. For example SAD may be used for both luma and chroma.

The weighting factors in equation (24a) may favor luma more than each chroma as luma may carry more information. The motion estimation block 620 may be enabled to search a reference picture, for example, Out(−1) within a search range 676. The first stage of this search may include integer MV positions. The lowest and second lowest cost MV's may be determined, and they may be labeled as MV#0 and MV#1, respectively.

The cost metric for neighboring half-pixel position MV's with a+/−½ pixel MV offset in with respect to the vector MV#0 may be determined. In accordance with an embodiment of the invention, the cost metric for eight neighboring half-pixel position MV's with a+/−½ pixel MV offset in both horizontal and vertical axes of the MV#0 may be determined. Alternatively, vectors along only the horizontal axis may be evaluated. The lowest cost MV and the second lowest cost MV may be updated during the half-pel search. The updated lowest cost MV and second lowest cost MV may be labeled as MV#0 and MV#1 respectively. The MV#1 may be utilized in a subsequent step for determining a confidence metric of the choice of MV#0. The half-pixel positions may be created using two-tap interpolation filters, for example.

The motion compensation (MC) block 622 may comprise suitable logic, circuitry and/or code that may be enabled to generate motion-compensated pixels from a reference image or previous output picture Out(−1), in the 4:4:4 format, by utilizing the lowest cost half-pel MV or MV#0 generated by the MC block 622.

The filter control block 624 may comprise suitable logic, circuitry and/or code that may be enabled to compare the current input image or picture In(0) at each pixel with the motion compensated result from the ME function using MV#0 on the previous output picture Out(−1), for example. These comparisons may be performed in the 4:4:4 format or alternatively in another format, for example the 4:2:2 format. The comparison may be performed using another measurement window that is similar in principle to the ME window 678. However, the filter control window may have a different size such as 5×3 or 7×5, for example. A cost metric may be generated over the measurement window, using a cost metric that may be similar to the ME cost metric. The filter cost metric may be represented as follows:

cost_{mc}_{_{—}}ᵢᵢᵣ=(2*luma_{—}SAD+abs(Cb_{—}SSD)+abs(Cr_{—}SSD)+2)/4 (24b)

The filter cost may be calculated for each pixel in the input picture In(0), and the ME cost may be calculated using windows of the input picture that may step by 3 pixels every MV, for example. The window for the filter cost, cost_{mc}_{_{—}}ᵢᵢᵣ may be centered at the pixel that is being filtered. The weighting factors in equation (24b) may favor luma more than each chroma as luma may carry more information.

In accordance with an embodiment of the invention, the filter cost window size may be configurable, for example, to be 7×5 or 5×3. The non-MC path filter cost window may also be configurable. The MC path and non-MC path filter cost window sizes may be independently configurable.

The filter cost value (filter_cost) may be mapped to filter coefficients of the IIR temporal filter in the MC path by utilizing the following non-linear transfer function:

α_{mc}_{_{—}}ᵢᵢᵣ=K₀(1−(K₁/d²)) (25)

where d=16*filter_cost/(size of window). The value 16 may be changed and other values may be utilized accordingly, to facilitate fixed point operations. K0 and K1 are parameters that may be set according to the desired degree of filtering corresponding to the noise level of the input video and/or the expectations of a subsequent encoder.

The MC path blending factor including non-linearities may be calculated as follows:

$$\begin{matrix}m = \frac{16 * {cost}_{mc\_iir}}{cost\_window \_size \_w * cost\_window \_size \_h} & ( 26 a ) \\ {α}_{mc\_iir} = {K}_{mc\_iir , 0} ( 1 - \frac{{K}_{mc\_iir , 1}}{{m}^{2}} ) . & ( 26 b ) \\ {α}_{mc\_iir} = clip 3 ( {α}_{mc\_iir} , LOW\_THD , 256 ) . & ( 26 c )\end{matrix}$$

where K_{mc}_{_{—}}_{iir,0} and K_{mc}_{_{—}}_{iir,1} are parameters that may be set according to the desired degree of filtering corresponding to the noise level of the input video and/or the expectations of a subsequent encoder and the function clip3( ) may be defined as follows:

```
int clip3(int x, int y, int z)
{
    if(x<y) return y;
    else if(x>z) return z;
    else return x;
}
```

Combining equations (24a) and (24b) with equation (26a), the normalized cost for the MC path may be approximated as follows:

m>>(b₀*luma_{—}SAD+b₁*abs(Cb_{—}SSD)+b₁*abs(Cr_{—}SSD))>>14 (26d)

where

b₀=((16*8192)/(cost_window_size_{—}w*cost_window_size_{—}h) (26e)

b₁=((16*4096)/(cost_window_size_{—}w*cost_window_size_{—}h) (26f)

In the above implementation, b₀ and b₁ may be programmable unsigned integer values, for example, since the window size may be programmable and may be constrained as follows:

b₀+2*b₁=(int)(262144/(cost_window_size_{—}w*cost_window_size_{—}h)) (26g)

The temporal filter 626 may comprise suitable logic, circuitry and/or code that may be enabled to generate a motion compensated output out_mc(0) to the blend block 528. The temporal filter in the MC path may be an IIR filter, for example. The feedback term or the output picture Out(−1) may be the previously generated output from the entire MCTF. The MC temporal filter 626 output may be specified as follows:

Out_mc(0)=((α_{MC}_{_{—}}_{IIR}*In(0))+(256−α_{MC}_{_{—}}_{IIR})*(mc(0))+128)/256 (27)

where α_{MC}_{_{—}}_{IIR} is the output of the filter control block 624, and mc(0) is the output of the motion compensation block 622.

In another embodiment of the invention, the even indexed samples may be filtered although both In(0) and Out(−1) have been converted to the 4:4:4 format for the chroma sample filtering operations. This may lower the cost without any significant impact on visual quality. The temporal filter 626 may be enabled to generate the resulting output in the 4:2:2 format, for example.

In another embodiment of the invention, the horizontal and vertical edge gradients may be calculated and utilized to adjust the blending control to combine the MC path output Out_mc(0) and non MC path output Out_nmc(0). The vertical gradient may be utilized to decrease the confidence level, and the horizontal gradient may offset the effect introduced by the vertical gradient, in order to reduce the flickering effect of near horizontal edges in the combined result. The edge strength calculations may be performed on the difference of the luma components of the current unfiltered picture In(0) and the previous output reference or filtered picture Out(−1).

The vertical gradient or the horizontal edge strength may be calculated by applying a plurality of filter templates to a neighborhood of the luma component that may correspond to the difference between the current input picture In(0) and the previous output picture Out(−1). The filter templates may be centered at the center pixel of a 3×1 pixel block, for example. The gradient may be calculated once for each 3×1 pixel block, for example. The plurality of filter templates may be represented, for example, as follows:

$$( \begin{matrix}1 & 1 & 1 & 2 & 1 & 1 & 1 \\ - 1 & - 1 & - 1 & - 2 & - 1 & - 1 & - 1 \\ 0 & 0 & 0 & 0 & 0 & 0 & 0 \end{matrix} ) and ( \begin{matrix}0 & 0 & 0 & 0 & 0 & 0 & 0 \\ 1 & 1 & 1 & 2 & 1 & 1 & 1 \\ - 1 & - 1 & - 1 & - 2 & - 1 & - 1 & - 1 \end{matrix} ) \qquad ( 28 )$$

The horizontal edge strength may be calculated, for example, as follows:

h_edge_{—}diff=max(abs(temp1), abs(temp2))/2 (29)

where temp1 and temp2 are the output values generated by applying the plurality of filter templates to a neighborhood of the luma component of the difference between the current input picture In(0) and the previous output picture Out(−1).

The horizontal gradient or the vertical edge strength may be calculated by applying the following two templates to the neighborhood of the luma difference between the current input picture In(0) and the previous output picture Out(−1), centered at the center pixel of the 3×1 pixel block, for example. The plurality of filter templates may be represented, for example, as follows:

$$( \begin{matrix}1 & 1 & - 1 & - 1 & 0 \\ 2 & 2 & - 2 & - 2 & 0 \\ 1 & 1 & - 1 & - 1 & 0\end{matrix} ) and ( \begin{matrix}0 & 1 & 1 & - 1 & - 1 \\ 0 & 2 & 2 & - 2 & - 2 \\ 0 & 1 & 1 & - 1 & - 1\end{matrix} ) \qquad ( 30 )$$

The vertical edge strength may be calculated for example, as follows:

v_edge_{—}diff=max(abs(temp3), abs(temp4))/2 (31)

where temp3 and temp4 are the output values generated by applying the plurality of filter templates to a neighborhood of the luma component of the difference between the current input picture In(0) and the previous output picture Out(−1). The final value of the edge strength that may be utilized to adjust the confidence level may be calculated, for example, as follows:

edge_strength_{—}adj=max(0, h_edge_{—}diff−v_edge_{—}diff) (32)

In order to improve noise reduction effectiveness it may be necessary to achieve both significant noise reduction in areas of little or no motion and be free of motion artifacts such as motion trails, motion blur, jittering or wobbling in areas where there is motion.

FIG. 6C is a block diagram of an MC path of another exemplary motion compensated temporal filtering system using infinite impulse response (IIR) filtering, in accordance with an embodiment of the invention. Referring to FIG. 6C, there is shown a MC filter module 670 that comprises a motion estimation block 620, a motion compensation block 622, a filter control block 624, an edge strength confidence and blending control block 625, and a temporal filter block 626.

The motion estimation (ME) block 620 may comprise suitable logic, circuitry and/or code that may be enabled to search a previous MCTF output picture Out(−1) in the search range 676 to find a motion vector (MV) in integer precision with a suitable fit, for example, lowest cost, with respect to a current input picture In(0) and then search a previous MCTF output picture Out(−1) around the first MV to find a motion vector in sub-pixel precision with a suitable fit, for example, lowest cost, with respect to a current input picture In(0). The previous MCTF output picture Out(−1) and the current input picture In(0) may be converted to the 4:4:4 format by the video converter 532. The set of pixels that are assigned one MV may be referred to as a pixel block. A pixel block may be as small as 1×1, or one pixel, or it may be larger. For example, the pixel block size may be 3×1 i.e. 3 pixels wide and 1 pixel tall. A pixel block size larger than 1×1 may be chosen to reduce implementation complexity for motion estimation and motion compensation. The implementation cost of the ME function may be related to the inverse of the pixel block size. The motion estimation (ME) block 620 may be enabled to receive the previous output picture Out(−1), and the current input picture In(0) and generate a plurality of motion vectors, MV#0 and MV#1, for example.

Each candidate motion vector may be evaluated using a cost metric measured over a window 678 of pixels. The size of the window 678 may be independent of the size of the pixel block. For example, the ME window size may be 7×5, i.e. 7 pixels wide and 5 pixels high. The ME block 620 may utilize a cost metric that may be a sum of absolute differences (SAD) for luma samples and sum of signed differences (SSD) for chroma samples. These cost metrics may be combined into one cost as follows, for example:

cost_{mc}_{_{—}}ᵢᵢᵣ=(2*luma_{—}SAD+abs(Cb_{—}SSD)+abs(Cr_{—}SSD)+2)/4 (24a)

where Cb_SSD and Cr_SSD are the SSD values of Cb and Cr components respectively. Alternatively, the cost metric may be defined as follows: cost_{mc}_{_{—}}ᵢᵢᵣ=(2*luma_SAD+Cb_SAD+Cr_SAD+2)/4, where Cb_SAD and Cr_SAD are the SAD values of Cb and Cr components respectively.

The weighting factors in equation (24a) may favor luma more than each chroma as luma may carry more information. The motion estimation block 620 may be enabled to search a reference picture, for example, Out(−1) within a search range 676. The first stage of this search may include integer MV positions. The lowest and second lowest cost MV's may be determined, and they may be labeled as MV#0 and MV#1, respectively.

The edge strength confidence and blending calculation block 625 may comprise suitable logic, circuitry and/or code that may be enabled to receive the cost metrics for the MV#0, MV#1 and the (0,0) motion vector, and the luma components of the current input picture In(0) and the previous output picture Out(−1). The edge strength adjustment value may be calculated substantially as in equations (28), (29),

(30), (31) and (32). A confidence value may be calculated substantially as in equations (11 a) and (11 b).

The motion compensation (MC) block 622 may comprise suitable logic, circuitry and/or code that may be enabled to generate motion-compensated pixels from a reference image or previous output picture Out(−1), by utilizing the lowest cost half-pel MV or MV#0 generated by the MC block 622.

The filter control block 624 may be substantially as described in FIG. 6B. The temporal filter 626 may comprise suitable logic, circuitry and/or code that may be enabled to generate a motion compensated output out_mc(0) to the blend block 528. The temporal filter in the MC path may be an IIR filter, for example. The feedback term or the output picture Out(−1) may be the previously generated output from the entire MCTF. The MC temporal filter 626 output may be specified as follows:

Out_mc(0)=((α_{MC}_{_{—}}_{IIR}*In(0))+(256−α_{MC}_{_{—}}_{IIR})*(mc(0))+128)/256 (27)

where α_{MC}_{_{—}}_{IIR} is the output of the filter control block 624, and mc(0) is the output of the motion compensation block 622.

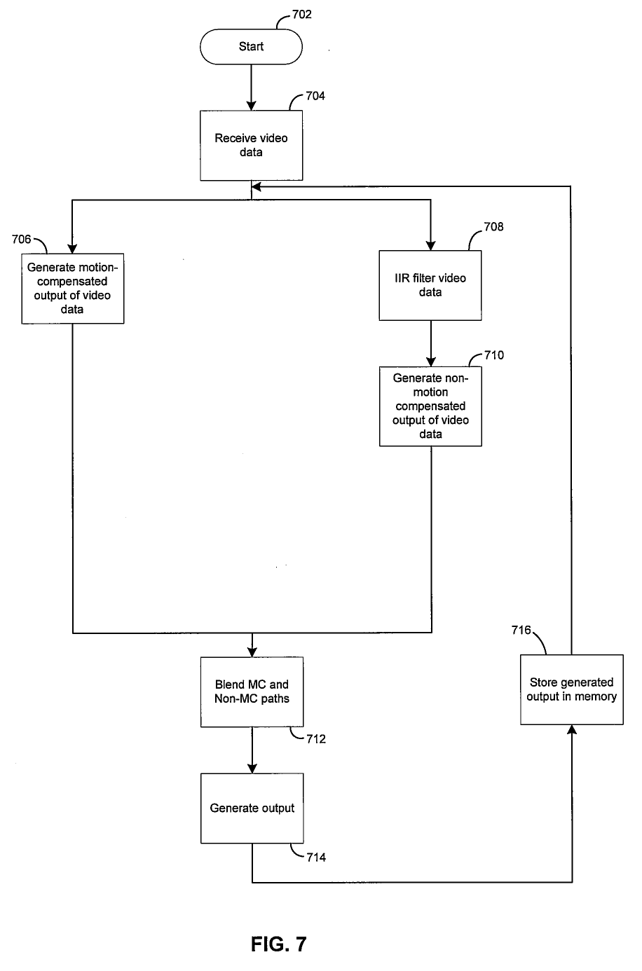

FIG. 7 is a flowchart illustrating exemplary steps for a motion compensated temporal filtering system using infinite impulse response (IIR) filtering, in accordance with an embodiment of the invention. Referring to FIG. 7, exemplary steps may begin at step 702. In step 704, the MCTF system may be enabled to receive and convert the video data. In step 706, the MC filter block 522 may be enabled to generate a motion compensated output picture of video data (Out_mc(0)). In step 708, the non-MC IIR filter 684 may be enabled to generate at least one infinite impulse response (IIR) filtered output picture (IIR_out(0)) of video data. In step 710, the non-MC IIR filter 684 may be enabled to generate at least one non-motion compensated output picture of video data (Out_nmc(0)).

In step 712, the blend block 528 may enable combining of the generated motion compensated output picture of video data (Out_mc(0)) and the generated non-motion compensated output picture of video data (Out_nmc(0)). In step 714, at least one output picture of video data (Out(0)) may be generated by utilizing the blended motion compensated output picture of video data (Out_mc(0)) and the generated non-motion compensated output picture of video data (Out_nmc(0)). In step 716, a previously generated portion of the output picture of video data (Out(−1)) may be fed back to the MC filter 522 and the non-MC filter block 524.

In accordance with an embodiment of the invention, a method and system for motion compensated temporal filtering using infinite impulse response (IIR) filtering may comprise at least one circuit, for example, a non-MC filter block 524 that enables generation of a corresponding non-motion compensated output picture of video data (Out_nmc(0)) from at least one infinite impulse response (IIR) filtered output picture of video data (IIR_out(0)). The MC filter module 670 may be enabled to generate a motion compensated output picture of video data (Out_mc(0)) by blending at least one motion compensated picture of video data mc(0) and at least one previously generated output picture of video data (Out(−1)).

The blend block 528 may enable combining of the motion compensated output picture of video data (Out_mc(0)) and the generated corresponding non-motion compensated output picture of video data (Out_nmc(0)). At least one output picture of video data (Out(0)) may be generated by utilizing the blended motion compensated output picture of video data (Out_mc(0)) and the generated corresponding non-motion compensated output picture of video data (Out_nmc(0)) and a previously generated portion of the output picture of video data (Out(−1)).

The MC filter block 522 may enable utilization of the previously generated portion of the output picture of video data (Out(−1)) to determine at least one motion vector (MV) based on a cost metric to represent a motion of the video data of at least one input picture of the video data (In(−1)). The motion compensated output picture of video data (Out_mc(0)) may be generated by utilizing at least one determined motion vector to represent the motion of video data. The MC filter block may also determine a confidence metric of the determined motion vector.

The blend calculation block 530 may be enabled to estimate the confidence metric of MV#0 by utilizing a combination of three metrics, for example, a first metric (cost_MV#1−cost_MV#0), which indicates how much lower MV#0 is than the next lowest cost MV, a second metric (cost_zero_MV−cost_MV#0), which indicates how much better MV#0 is compared to the zero (0,0) vector, and a third metric may be the horizontal edge strength, edge_strength_adj. These metrics may be combined, for example, as follows:

confidence_{—}mv=max((cost_zero_{—}MV−cost_{—}MV#0), (cost_{—}MV#1−cost_{—}MV#0) (11a)

confidence=max(0, confidence_{—}mv−edge_strength_{—}adj) (11b)

The motion compensated output picture of video data (Out_mc(0)) may be generated by temporal filtering of video data with the determined motion vector (MV). The temporal filter in the MC path may be an IIR filter, for example. The feedback term or the output picture Out(−1) may be the previously generated output from the entire MCTF. The MC temporal filter 626 output may be specified, for example, as follows:

Out_{—}mc(0)=((α_{MC}_{_{—}}_{IIR}*In(0))+(256−α_{MC}_{_{—}}_{IIR})*(mc(0))+128)/256 (27)

where α_{MC}_{_{—}}_{IIR} is the output of the filter control block 624, and mc(0) is the output of the motion compensation block 622. The constants in equations (27) may be set according to a degree of filtering corresponding to a noise level of an input video and/or the expectations of a subsequent encoder.

The cost metric may comprise a combination of a sum of absolute differences (SASD) for luma components of video data and a sum of signed differences (SSD) for chroma components of video data. A cost metric may be generated over the measurement window, using a cost metric that may be similar to the ME cost metric. The filter cost metric may be represented, for example, as follows:

cost_{mc}_{_{—}}ᵢᵢᵣ=(2*luma_SAD+abs(Cb_SSD)+abs(Cr_SSD)+2)/4 (24b)

### The filter cost may be calculated for each pixel in the input picture In(0), and the ME cost may be calculated using windows of the input picture that may step by 3 pixels every MV, for example.

The motion vector (MV) may be determined based on a lowest cost of a plurality of candidate MVs that may be applied to at least one input picture of video data (In(0)). The motion estimation (ME) block 620 may be enabled to search a previous MCTF output picture out(−1) after being converted to the 4:4:4 format in the search range 676 to find a motion vector (MV) with a suitable fit, for example, lowest cost, with respect to a current input picture In(0) after being converted to the 4:4:4 format. Alternatively, the ME block 620 may be enabled to search a previous MCTF output picture out(−1) with respect to a current input picture In(0) without converting to the 4:4:4 format. Suitable interpolation may be applied to the chroma samples to enable the motion estimation function.

The previously generated portion of the output picture of video data (Out(−1)) may be fed back to the MC filter block 522 to determine the motion compensated output picture of video data (Out_mc(0)). The previously generated portion of the output picture of video data (Out(−1)) may be fed back to the non-MC filter block 524 to determine the generated corresponding non-motion compensated output picture of video data (Out_nmc(0)). A blending factor, α_{blend} may be determined for blending the motion compensated output picture of video data (Out_mc(0)) and the generated corresponding non-motion compensated output picture of video data (Out_nmc(0)). A horizontal edge gradient and/or a vertical edge gradient may be calculated to adjust the determined blending factor α_{blend}. The vertical gradient may be utilized to decrease the confidence level, and the horizontal gradient may offset the effect introduced by the vertical gradient, in order to reduce the flickering effect of near horizontal edges in the combined result. At least one IIR filtered output picture of video data (IIR_out(0) may be generated based on an IIR blending factor αᵢᵢᵣ. The IIR blending factor αᵢᵢᵣ may be dynamically modified based on a motion metric parameter.

Accordingly, the present invention may be realized in hardware, software, or a combination thereof. The present invention may be realized in a centralized fashion in at least one computer system, or in a distributed fashion where different elements may be spread across several interconnected computer systems. Any kind of computer system or other apparatus adapted for carrying out the methods described herein may be suited. A typical combination of hardware and software may be a general-purpose computer system with a computer program that, when being loaded and executed, may control the computer system such that it carries out the methods described herein. The present invention may be realized in hardware that comprises a portion of an integrated circuit that also performs other functions.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing video data, the method comprising:
blending at least one motion compensated picture of video data and at least one previously generated output field of said video data to generate at least one motion compensated output picture of said video data;
generating a corresponding non-motion compensated output picture of said video data from an infinite impulse response (IIR) filtered output picture of said video data;
blending said generated motion compensated output picture of said video data and said generated corresponding non-motion compensated output picture of said video data; and
generating at least one current output picture of said video data, utilizing said generated motion compensated output picture of said video data and said generated corresponding non-motion compensated output picture of said video data.

2. The method according to claim 1, comprising generating a motion vector to represent motion of said video data based on a cost metric corresponding to an input picture of said video data.

3. The method according to claim 2, comprising determining a confidence metric of said generated motion vector to represent said motion of said video data.

4. The method according to claim 2, comprising generating said motion compensated output picture of said video data by filtering said video data utilizing said determined motion vector.

5. The method according to claim 2, wherein said cost metric comprises a combination of a sum of absolute differences for luma components of said video data and an absolute value of a sum of signed differences for chroma components of said video data.

6. The method according to claim 2, wherein said cost metric comprises a combination of a sum of absolute differences for luma components of said video data and a sum of absolute differences for chroma components of said video data.

7. The method according to claim 2, comprising determining said motion vector based on a lowest cost value of said cost metric.

8. The method according to claim 1, comprising feeding back said at least one previously generated output picture of said video data for generating said motion compensated output picture of said video data.

9. The method according to claim 1, comprising feeding back said at least one previously generated output picture of said video data for said generating said corresponding non-motion compensated output picture of said video data.

10. The method according to claim 1, comprising determining a blending factor for blending said generated motion compensated output picture of said video data and said generated corresponding non-motion compensated output picture of said video data.

11. The method according to claim 10, comprising calculating at least one of: a horizontal edge gradient and a vertical edge gradient to adjust said determined blending factor.

12. The method according to claim 1, comprising generating said IIR filtered output picture of said video data based on an IIR blending factor.

13. The method according to claim 12, comprising dynamically modifying said IIR blending factor based on a motion metric parameter.

14. A system for processing video data, the system comprising:
at least one circuit that enables blending of at least one motion compensated picture of video data and at least one previously generated output picture of said video data to generate at least one motion compensated output picture of said video data;
said at least one circuit enables generation of a corresponding non-motion compensated output picture of said video data from an infinite impulse response (IIR) filtered output picture of said video data;
said at least one circuit enables blending of said generated corresponding motion compensated output picture of said video data and said generated corresponding non-motion compensated output picture of said video data; and
said at least one circuit enables generation of at least one current output picture of said video data, utilizing said blended motion compensated output picture of said video data and said generated corresponding non-motion compensated output picture of said video data.

15. The system according to claim 14, wherein said at least one circuit enables generation of a motion vector to represent motion of said video data based on a cost metric corresponding to an input picture of said video data.

16. The system according to claim 15, wherein said at least one circuit enables determining a confidence metric of said generated motion vector to represent said motion of said video data.

17. The system according to claim 15, wherein said at least one circuit enables generation of said motion compensated output picture of said video data by filtering said video data utilizing said determined motion vector.

18. The system according to claim 15, wherein said cost metric comprises a combination of a sum of absolute differences for luma components of said video data and an absolute value of a sum of signed differences for chroma components of said video data.

19. The system according to claim 15, wherein said cost metric comprises a combination of a sum of absolute differences for luma components of said video data and a sum of absolute differences for chroma components of said video data.

20. The system according to claim 15, wherein said at least one circuit enables determining said motion vector based on a lowest cost value of said cost metric.

21. The system according to claim 14, wherein said at least one circuit enables feeding back of said at least one previously generated output picture of said video data for said generation of said motion compensated output picture of said video data.

22. The system according to claim 14, wherein said at least one circuit enables feeding back of said at least one previously generated output picture of said video data for generating said corresponding non-motion compensated output picture of said video data.

23. The system according to claim 14, wherein said at least one circuit enables determining a blending factor for blending said generated motion compensated output picture of said video data and said generated corresponding non-motion compensated output picture of said video data.

24. The system according to claim 23, wherein said at least one circuit enables calculation of at least one of: a horizontal edge gradient and a vertical edge gradient to adjust said determined blending factor.

25. The system according to claim 14, wherein said at least one circuit enables generation of said IIR filtered output picture of said video data based on an IIR blending factor.

26. The system according to claim 25, wherein said at least one circuit enables dynamically modifying said IIR blending factor based on a motion metric parameter.
